(19) United States
(12) Patent Application Publication
(10) Pub. No.: US 2004/0074748 A1
(43) Pub. Date: Apr. 22, 2004

(54) Supporting base for a circuit breaker

(76) Inventors: Lucio Azzola, Bergamo (IT); Stefano Besana, Terno d'Isola (IT)

Correspondence Address: CONNOLLY BOVE LODGE & HUTZ LLP, SUITE 800, 1990 M STREET NW, WASHINGTON, DC, 20036-3425, US

(21) Appl. No.: 10/451,878

(22) PCT Filed: Dec. 12, 2001
(86) PCT No.: PCT/EP01/14698

(30) Foreign Application Priority Data
Dec. 29, 2000 (IT) MI00A002874

(51) Int. Cl. H01J 1/00

(52) U.S. Cl. 200/237

(57) ABSTRACT

A supporting base for a low-voltage power circuit breaker of the draw-out or removable type, comprising a substantially parallelepipedal body that has a rear wall, a front wall, two side walls, an upper wall and a lower wall, first and second terminals being provided respectively on the upper and lower walls in order to provide direct or indirect electrical connection to corresponding conductors of a power supply circuit; its particularity consists of the fact that third and fourth terminals are provided on the front wall and are suitable to facilitate electrical coupling to corresponding coupling terminals provided on the circuit breaker, the thrid and fourth electrical terminals being spaced from and electrically connected to, respectively, the first and second terminals.

### DESCRIPTION

The present invention relates to a supporting base for a low-voltage power circuit breaker of the draw-out or removable type having improved functions and characteristics; more specifically, the expression “low-voltage power circuit breaker” is to be understood as designating a circuit breaker suitable for applications with operating voltages under 1000 volts.

Generally, low-voltage industrial electrical systems normally use specific devices commonly known in the art as automatic circuit breakers or power circuit breakers; said circuit breakers operate with high currents whose nominal value, depending on the applications, can vary over a wide range and are conceived so as to provide a series of performance features required to ensure the correct operation of the electric power supply circuit that they protect and of the loads connected thereto. For example, they protect the loads from abnormal events caused by short-circuit faults or due to overloads by automatically opening said power supply circuit, they allow the correct insertion/disengagement of loads in/from the electrical power supply circuit, they ensure that the nominal current for the various users is actually equal to the required current, et cetera.

The circuit breakers are currently normally used in electrical systems by installing them in appropriate distribution panels, so as to ensure correct functionality, safety, practical and ergonomic use, and possibly also the good aesthetic appearance of the assembly.

In practical applications, distribution panels differ from each other in their various constructive configurations in many constructive and functional aspects, such as for example the dimensions, the materials used, the provision of inspection and/or protection doors, the types of apparatus and conductor used, their mutual connections, and others.

The choice of the type of circuit breaker to use and of the installation methods must therefore be made by taking in account the specific characteristics of the panel in which the circuit breaker is applied; currently, in order to meet the various requirements, there are substantially three types of installation of circuit breakers in panels. In particular, a first constructive solution is the so-called fixed configuration, in which the circuit breaker is mechanically coupled directly to a supporting element of the panel, for example a mounting plate, and is electrically connected to the conductors of a power supply circuit by virtue of its own electric terminals. A second constructive solution is the so-called removable configuration, in which a special supporting base is used which is mechanically coupled to an element of the panel and is connected to the conductors of the power supply circuit by virtue of its own electric terminals; the circuit breaker is engaged mechanically on said base and is electrically connected thereto by using appropriate additional terminals provided on the circuit breaker and on the base. A third solution, known as draw-out configuration, essentially differs from the removable one in that the engagement of the circuit breaker on the fixed part occurs by using particular guiding and supporting means.

Generally, both the circuit breakers and the supporting bases are provided with electrical connection terminals that are conceived according to a basic standard configuration; however, not all system solutions are suitable for establishing electrical connections directly by means of terminals of the above type; in such cases it is therefore necessary to apply adapter accessories constituted by additional electrical terminals that are configured differently according to the application in which they will be used and are connected to the basic standard terminals. Furthermore, in the current state of the art known types of supporting base are provided by arranging the terminals for connection to the circuit breakers proximate to the terminals for connection to the conductors of the power supply circuit. Accordingly, in view of the mechanical and electrical constraints that have to be met, the regions of the supporting bases in which the terminals are arranged, as well as the terminals themselves, have a constructive configuration that is different from that of the corresponding parts of the circuit breakers.

Accordingly, the number of potentially usable adapter accessories varies according not only to the type of practical application but also according to whether they are to be applied directly to the electrical terminals of the circuit breaker or to the electrical terminals of the supporting base. Moreover, the fact should be stressed that in addition to the adapter accessories required for the electrical connection of the terminals of the circuit breaker or of the supporting base to the conductors of the power supply circuit, additional accessories, generally protective ones, are used, such as for example insulating barriers between the phases, high terminal covers, low terminal covers, et cetera; these accessories also currently have to be provided in mutually different shapes, depending on whether they are to be applied to the supporting bases or on the circuit breakers themselves.

Accordingly, in order to meet the various application requirements it is necessary to produce a significantly large number of adapting and protective accessories, with negative consequences both on production costs and on inventory management costs, offering users a range of solutions that is not optimized from the point of view of standardization.

The aim of the present invention is to obviate the drawbacks of the prior art and in particular to provide a supporting base for a low-voltage power circuit breaker of the draw-out or removable type that allows to unify, and therefore reduce, the number of accessories that can be used potentially, regardless of whether they are to be used on the supporting base or on the circuit breaker itself, so as to reduce production costs and inventory management costs, and offer a range of solutions that are more standardized than the current state of the art.

This aim, as well as other purposes that will become better apparent hereinafter are achieved by a supporting base for a low-voltage power circuit breaker of the draw-out or removable type, comprising a substantially parallelepipedal body that has a rear wall, a front wall, two side walls, an upper wall and a lower wall, first and second terminals being provided respectively on said upper and lower walls in order to provide direct or indirect electrical connection to corresponding conductors of a power supply circuit, characterized in that third and fourth terminals are provided on said front wall and are suitable to facilitate electrical coupling to corresponding coupling terminals provided on the circuit breaker, said third and fourth electrical terminals being spaced from and electrically connected to, respectively, said first and second terminals.

Further characteristics and advantages will become better apparent from the description of preferred but not exclusive embodiments of the supporting base according to the invention, illustrated only by way of non-limitative example with the aid of the accompanying drawings, wherein:

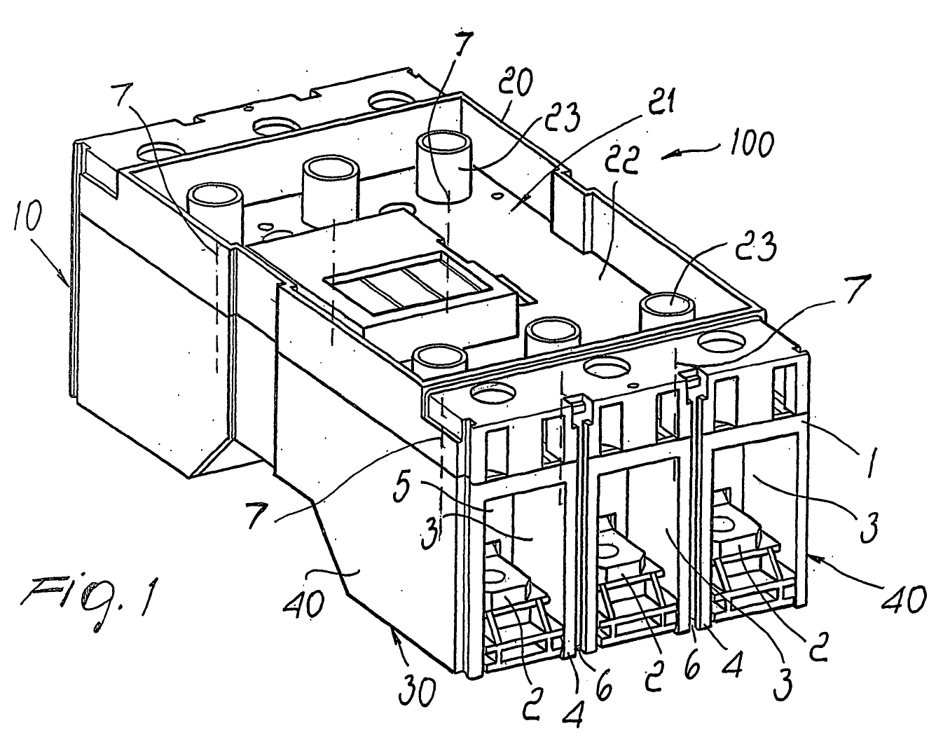

FIG. 1 is a perspective view of a supporting base according to the invention;

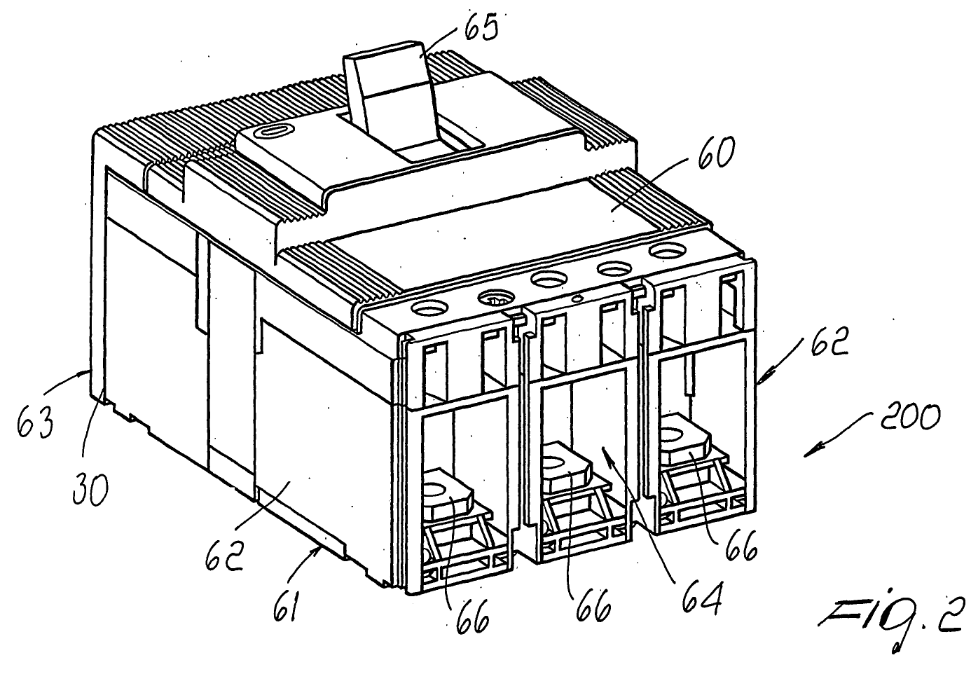

FIG. 2 is a perspective view of a low-voltage power circuit breaker that can be applied to the supporting base of FIG. 1;

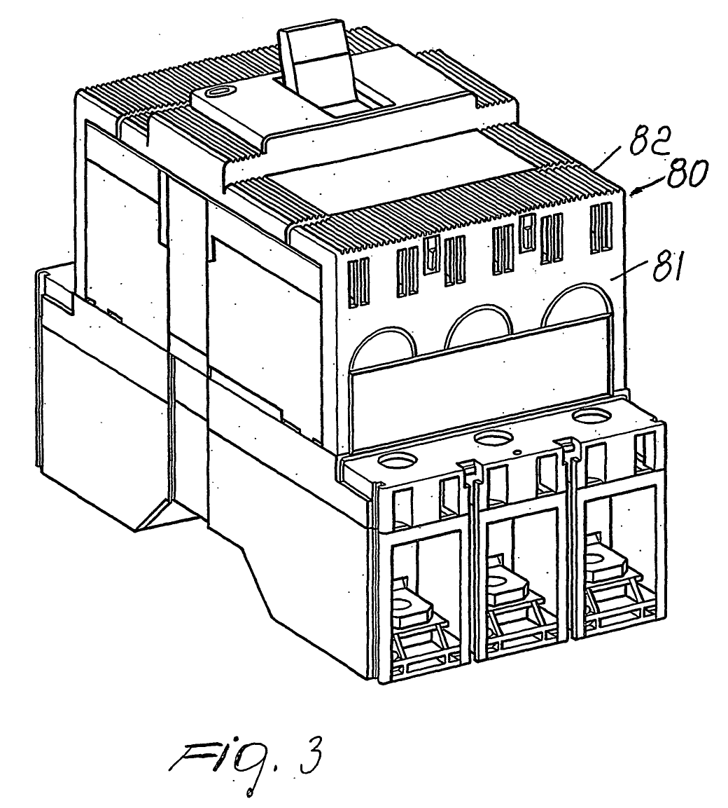

FIG. 3 is a perspective view of the circuit breaker of FIG. 2, coupled to the supporting base of FIG. 1 in a configuration of the removable type;

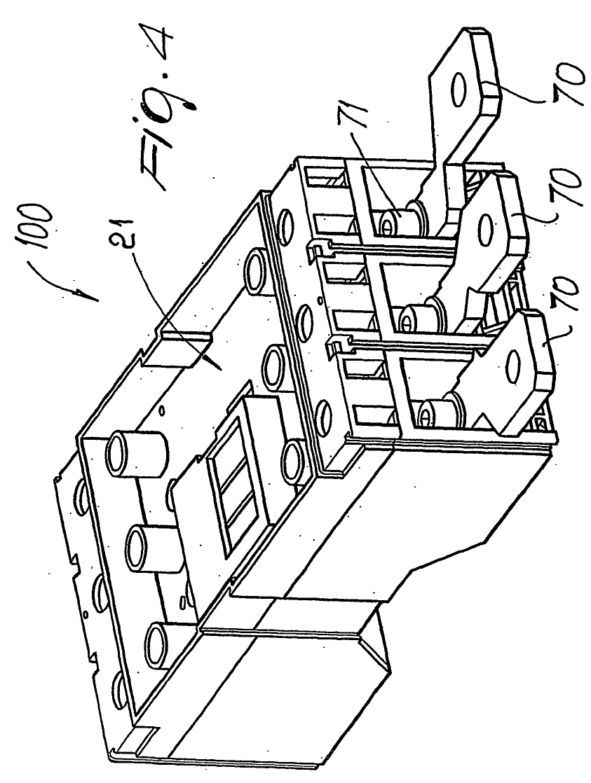

FIG. 4 is a perspective view of the supporting base coupled to additional adapter terminals of the divaricated type;

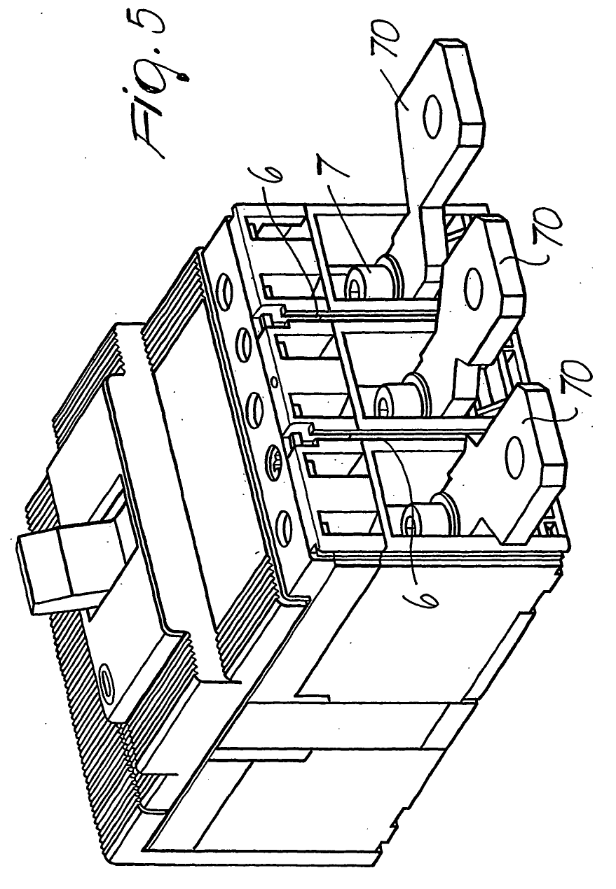

FIG. 5 is a perspective view of a low-voltage power circuit breaker coupled to identical additional adapter terminals of the divaricated type;

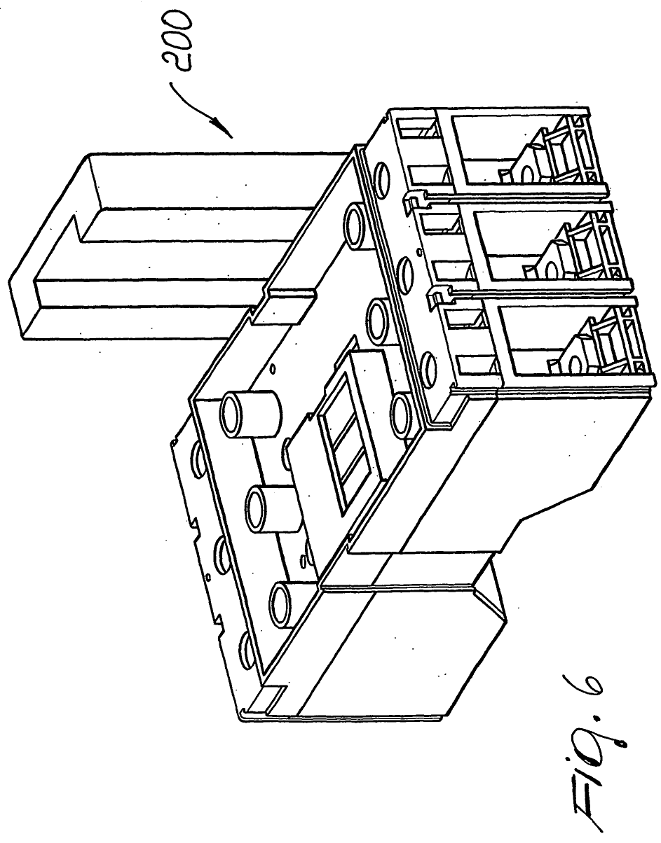

FIG. 6 is a perspective view of the base of FIG. 1, associated with a guiding element for the installation of a circuit breaker in the draw-out configuration.

In the description that follows, the same reference numerals designate elements that are identical or technically equivalent one another.

With reference to FIG. 1, the supporting base according to the invention comprises a body 100 that is appropriately configured so as to mate with a low-voltage power circuit breaker and allow the installation of said circuit breaker according to a draw-out or removable configuration in the manners that will become apparent in greater detail from the description that follows; in particular, a low-voltage power circuit breaker, as shown in FIG. 2, generally comprises an enclosure that has a front wall 60, a rear wall 61, two side walls 62, a lower wall 63, and an upper wall 64; the enclosure contains, according to embodiments that are widely known in the art and therefore are not illustrated in detail, at least one fixed contact and at least one movable contact that can be mutually coupled/uncoupled and means for actuating the movable contact. Externally to the enclosure there is also a lever 65, which is operatively coupled to the actuation means and allows to reset the circuit breaker, and there are electrical terminals 66, which are suitable to be connected electrically, directly or indirectly, to the conductors of a power supply circuit; furthermore, when the circuit breaker is used mounted on a supporting base, it is provided with additional coupling terminals, not shown, that are electrically connected to the electrical terminals 66 and are suitable to facilitate the electrical connection to the supporting base associated therewith; said coupling terminals might be provided, for example, according to a tulip configuration of a known type.

In the embodiment of the supporting base according to the invention, the body 100 has a substantially parallelepipedal shape with an upper wall 1, a lower wall 10, a front wall 20, a rear wall 30, and two side walls 40. First and second terminals 2 are provided respectively on the upper wall 1 and on the lower wall 10 for direct or indirect electrical connection to corresponding conductors of a power supply circuit, not shown; in the figures, only the shape of the upper wall 1 and of the terminals 2 arranged thereon is illustrated in detail, since the configuration of the lower wall 10 is similar to the configuration of the wall 1 and the corresponding terminals 2 are fully equivalent to each other.

Advantageously, third and fourth terminals are provided on the front wall 20 of the body 100 and are respectively electrically connected to the first and second terminals 2 provided on the upper wall 1 and on the lower wail 10, and are arranged so as to be spaced and segregated from them; said third and fourth terminals, schematically indicated by the dashed lines 7, are suitable to facilitate electrical coupling to the corresponding coupling terminals provided on the circuit breaker.

In particular, as shown in detail in FIGS. 1 and 4, the front wall 20 has, in a substantially central region, a seat 21 that is suitable to receive and accommodate a rear portion of the circuit breaker; on the bottom face 22 of the seat 21 there are, on two substantially parallel rows, hollow cylindrical bodies 23 that protrude transversely from the bottom face 22 of the seat and accommodate inside them the third and fourth terminals 7 for electrical coupling to the circuit breaker.

In this manner, the upper wall 1 and the lower wall 10 of the body of the supporting base are freed from the presence of the terminals for coupling to the circuit breaker and can be shaped mainly according to the manufacturing requirements of the terminals for direct or indirect electrical connection to the conductors of a power supply circuit.

In particular, in the supporting base according to the invention the upper wall 1, as well as the lower wall 10, has multiple receptacles 3 in which the corresponding electrical terminals 2 are arranged; said receptacles 3 are mutually separated by partitions 4 that lie along the imaginary line which connects the front wall 20 and the rear wall 30 and have, on a surface that is substantially parallel to the bottom surface 5 of the compartments 3, slots 6 that have a substantially straight axis. In this manner, one has the great advantage 25 that the structure of the upper wall 1 and of the lower wall 10 of the base is substantially identical to the configuration of the corresponding walls 64 and 63 of the circuit breaker, with respective terminals 2 and 66 for connection to the conductors of the electrical circuit that are identical to each other.

Accordingly, depending on system applications, if it is necessary to use additional terminals that allow to adapt the connection to the configuration of the system, the additional terminals to be used are the same both when only the circuit breaker in the fixed configuration is applied and therefore said terminals must be applied to the terminals 66, and when said additional terminals must be connected to the terminals 2 of the supporting base according to an installation in a removable or draw-out configuration.

An example of this possibility is shown in detail in FIGS. 4 and 5, which clearly show additional terminals 70 of the front divaricated type which are connected, by means of ordinary fixing means 71, directly to the terminals 2 of the supporting base according to the invention and to the terminals 66 of the circuit breaker, respectively.

Clearly, this solution can be fully implemented also with other types of additional terminals, for example with extended front terminals, with rear terminals, et cetera; furthermore, according to a solution that is flexible from the point of view of application, the terminals 2 can be connected to the conductors of the power supply circuit, by virtue of the adapter terminals, through the upper and lower walls, as shown in FIG. 4, or also through the rear wall 30.

The fact that, in addition to the shape of the terminals, also the structure of the upper and lower walls of the supporting base is substantially identical to the structure of the corresponding parts of the circuit breaker that can be coupled thereto, allows to have additional advantages also as regards the use of further types of accessory that are used, for example protective ones, in addition to the previously mentioned adapter accessories. An example of protective accessory is constituted by terminal covering elements, which can be for example of the low type, shown in FIG. 3 coupled to the circuit breaker, or of the high type. In particular, the covering element 80, which can be applied both to the lower wall and to the upper wall of the base or of the circuit breaker, comprises a first portion 81 and a second portion 82 that are substantially flat and are arranged in an L-shaped configuration with respect to each other; the first portion 81 is provided with diaphragms (not visible in the figure) that are suitable to slidingly mate with the slots 6 of the partitions and is suitable to close the compartments and cover the terminals arranged therein, while the second portion 82 is suitable to abut against an end portion of the corresponding front wall. The use of this accessory on the base allows to attain IP4X protection ratings (according to IEC standards) with respect to the electrical connection terminals without having to resort to additional insulating barriers, as occurs in the known art.

The present invention, in a further aspect thereof, in fact also relates to a device for protecting an electric circuit, which comprises:

a supporting base as described above; and

a power circuit breaker of the draw-out or removable type, suitable to be coupled to the supporting base at its front wall; the circuit breaker is provided, according to solutions known per se, with fifth and sixth electrical terminals that are suitable to be electrically connected respectively to the third and fourth terminals of the base and with seventh and eighth terminals that are electrically connected respectively to said fifth and sixth terminals (for example the terminals 66 of FIG. 2) in input to, and in output from, said circuit breaker.

In greater detail, in the draw-out configuration the above described protective device also comprises a shaped guiding element 200 that is coupled to a side wall of the supporting base; the guiding element is suitable to facilitate the coupling of the circuit breaker to the supporting base and the insertion of mechanical means suitable to facilitate its extraction from the base.

In practice it has been found that the supporting base according to the invention fully achieves the intended aim, since it is possible to use adapting and protective accessories that are mutually identical, regardless of whether they are to be used on the circuit breaker or on the base. The supporting base thus conceived is susceptible of modifications and variations, all of which are within the scope of the inventive concept.

All the details may further be replaced with technically equivalent elements. In practice, the materials used, so long as they are compatible with the specific use, as well as the contingent shapes and dimensions, may be any according to requirements and to the state of the art.

1. A supporting base for a low-voltage power circuit breaker of the draw-out or removable type, comprising a substantially parallelepipedal body that has a rear wall, a front wall, two side walls, an upper wall and a lower wall, first and second terminals being provided respectively on said upper and lower walls in order to provide direct or indirect electrical connection to corresponding conductors of a power supply circuit, characterized in that third and fourth terminals are provided on said front wall and are suitable to facilitate electrical coupling to corresponding coupling terminals provided on the circuit breaker, said third and fourth electrical terminals being spaced from and electrically connected to, respectively, said first and second terminals.

2. The supporting base according to claim 1, characterized in that said front wall has, in a substantially central region a seat that is suitable to receive said circuit breaker, said third and fourth terminals being arranged respectively on the bottom face of said compartment along two substantially parallel rows.

3. The supporting base according to claim 2, characterized in that said third and fourth terminals are arranged so as to be at least partially accommodated in hollow cylindrical bodies that protrude transversely from said bottom face of the compartment and are suitable to receive said coupling terminals provided on the circuit breaker.

4. The supporting base according to one or more of the preceding claims, characterized in that said first and second terminals are connected to said conductors of the power supply circuit through said upper and lower walls by means of adapter terminals.

5. The supporting base according to one or more of claims 1 to 3, characterized in that said first and second terminals are connected to said conductors of the power supply circuit, through said rear wall, by means of adapter terminals.

6. The supporting base according to one or more of the preceding claims, characterized in that said upper wall and/or said lower wall have receptacles in which said first and second electrical terminals are respectively arranged, said receptacles being mutually separated by partitions that run along the line that connects the front wall and the rear wall and have, on a surface that is substantially parallel to the bottom surface of the receptacles, slots that have a substantially straight axis.

7. The supporting base according to one or more of the preceding claims, characterized in that it comprises at least one covering element that is suitable to be coupled to said parallelepipedal body at said upper or lower wall, said covering element having a first portion and a second portion that are substantially flat and arranged in an L-shaped configuration with respect to each other, said first portion being provided with diaphragms that are suitable to slidingly couple to said slots of the partitions and being suitable to close said compartments and cover the terminals arranged therein, said second portion being suitable to abut against an end portion of said front wall of the body.

8. A device for protecting an electrical circuit, characterized in that it comprises:
a supporting base according to one or more of the preceding claims;
a power circuit breaker of the draw-out or removable type, suitable to be coupled to said supporting base at said front wall, said circuit breaker being provided with fifth and sixth electrical terminals that are suitable to be electrically connected respectively to said third and fourth terminals of the base and with seventh and eighth terminals that are electrically connected to said fifth and sixth terminals, respectively, in input and in output to said circuit breaker.

9. The protective device according to claim 8, characterized in that said first terminals of the supporting base and said seventh terminals of the circuit breaker are mutually identical and/or said second terminals of the supporting base and said eighth terminals of the circuit breaker are mutually identical.

10. The protective device according to claims 8 and 9, characterized in that the configuration of the upper wall and/or of the lower wall of the supporting base is substantially identical to the configuration of the corresponding walls of the circuit breaker.

11. A protective device according to one or more of claims 8 to 10, characterized in that it comprises a shaped guiding element that is coupled to a side wall of said supporting base, said guiding element being suitable to facilitate the coupling of said circuit breaker to the supporting base and the insertion of mechanical means suitable to facilitate its extraction from the base.
